(19) United States
(12) Patent Application Publication
(10) Pub. No.: US 2019/0273646 A1
(43) Pub. Date: Sep. 5, 2019

(54) APPARATUS AND METHOD FOR ESTIMATING CARRIER FREQUENCY OFFSET

(71) Applicant: MStar Semiconductor, Inc., Hsinchu Hsien (TW)

(72) Inventors: Yi-Ying LIAO, Hsinchu Hsien (TW); Ko-Yin LAI, Hsinchu Hsien (TW); Tai-Lai TUNG, Hsinchu Hsien (TW)

(21) Appl. No.: 15/962,162

(22) Filed: Apr. 25, 2018

(30) Foreign Application Priority Data
Mar. 5, 2018 (TW) 107107318

(51) Int. Cl. H04L 27/26

(52) U.S. Cl. CPC H04L 27/2657

(57) ABSTRACT

An apparatus for estimating a carrier frequency offset (CFO) is provided. A differential correlation calculation is performed on a received signal and a reference signal to generate multiple calculation results. One among M number of peak values with largest amplitudes determined from the calculation results is selected as a candidate peak value and outputted each time. A data capturing circuit captures from the received signal a data segment corresponding to the candidate peak value as a candidate data segment. A fast Fourier transform (FFT) circuit performs FFT on a product of the candidate data segment and a conjugate signal of reference data to obtain a candidate transform result. A selecting circuit determines whether to select the candidate transform result as a target transform result. The CFO calculating circuit determines an estimated CFO according to a frequency corresponding to the largest amplitude in the target transform result.

This application claims the benefit of Taiwan application Serial No. 107107318, filed Mar. 5, 2018, the subject matter of which is incorporated herein by reference.

### BACKGROUND OF THE INVENTION

### Field of the Invention

The invention relates a communication system, and more particularly to a technology for estimating a carrier frequency offset (CFO) in a communication system.

### Description of the Related Art

Various types of communication systems get more and more popular as related technologies in the field of electronics continue to advance. Each of a transmitter and a receiver of a communication system is provided with at least one oscillation signal source (e.g., a quartz oscillator) that provides a clock signal as a reference basis for circuit operations. During an operation process, clock frequencies of the transmitter and the receiver need to achieve certain consistency in order to enable the receiver correctly parse signals sent from the transmitter.

If the frequency of a local clock signal used for down-conversion at a receiving end differs from a carrier frequency applied to signals at a transmitting end, carrier frequency offset (CFO) is present. The CFO may lead to inter-carrier interference, and also cause the receiver unable to parse the received signal A usual cause of the CFO is mismatch between respective oscillators at a transmitting end and a receiving end. In practice, a transmitting end and a receiving end may be fabricated by different manufactures based on different hardware of different specifications, and matching between the oscillators at these two ends is extremely difficult. Thus, the receiving end is usually designed with a mechanism for compensating the CFO. It is obvious that, it is desired to first correctly estimate the value of the CFO before CFO compensation can be effectively conducted.

An output signal from a transmitting end includes data of certain content for a receiving end to perform channel estimation and CFO estimation. Taking the Digital Terrestrial Multimedia Broadcast (DTMB) standard adopted in the Mainland China region for instance, a signal is formed by a series of alternating frame headers and frame bodies. Each frame header includes a binary sequence. In different transmission modes, the lengths and contents of the binary sequence are different. Given that a current transmission mode is known, a receiving end is able to learn the length and original content of the binary sequence. On main task of a receiving end, before performing CFO estimation, is identifying a position of the binary sequence in a received signal.

FIG. 1(A) shows a function block diagram of a CFO estimating apparatus in a current DTMB receiving end. A coherent correlator 110, a time-domain peak searching circuit 120 and a data capturing circuit 130 identify the position of the binary sequence from the received signal, and capture the binary sequence. A fast Fourier transform (FFT) circuit 140, a frequency-domain peak searching circuit 150 and an CFO calculating circuit 160 perform CFO estimation according to the binary sequence, with associated details given below.

The input signal of the coherent correlator 110 includes a received signal (to be denoted by a symbol r) and original content (to be denoted by a symbol c) of the binary sequence known to the receiving end, and a calculation process can be represented as equation (1) below:

R(n)=Σᵢ₌₀^{L-1}r(n−L+i+1)c*(i) (1)

In equation (1), the symbol n represents a time index, the symbol r(n) represents data content of the received signal r corresponding to the time point n, the symbol L represents the length of the binary sequence c, the symbol i represents an integral index, the symbol c*(i) represents an i^{th} set of data in the binary sequence c, the symbol c(i) is a conjugate signal of the i^{th} set of data, and the symbol R(n) represents a calculation result of the coherent correlator 110 corresponding to the time point n.

The coherent correlator 110 determines calculation results R(n) respectively corresponding to multiple time points n. Theoretically, a greater absolute value |R(n)| of the calculation result R(n) indicates a higher resemblance of a data segment to the binary sequence c, where the data segment has length L ending at the time point n in the received signal r. Thus, the time-domain peak searching circuit 120 collects multiple calculation results R(n), and determines therefrom one calculation R(n) having a largest amplitude (i.e., the square |R(n)|² of the absolute value |R(n)| of the calculation result) R(n)).

Assuming that the time-domain peak searching circuit 120 determines that the amplitude |R(n)|² corresponding to the time point n₁ is the largest, the data capturing circuit 130 captures L sets of data corresponding to the time point n₁ from the received signal r, namely, {r(n₁−L+1), r(n₁−L+2), . . . , r(n₁)}, and provides the same as a target data segment y={y(0), y(1), . . . , y(L−1)} to the FFT circuit 140.

The FFT circuit 140 calculates product of the target data segment y and a conjugate signal of the binary sequence c, and performs FFT on the product. The associated calculation may be represented as equation (2) below:

Γ(k)=Σₙ₌₀^{L-1}y(n)c*(n)e^{-j2πnk/N} (2)

In equation (2), the symbol N represents the resolution of the FFT (i.e., the total number of frequencies), and the symbol k is an integral index (to be referred to as a frequency index k below) ranging between 0 and (N−1).

The FFT circuit 140 in total generates N transform results Γ(k) (k=0˜(N−1)) corresponding to N frequencies. The frequency-domain peak searching circuit 150 determines a transform result having the largest amplitude from the N transform results Γ(k), and obtains the frequency index k (to be denoted by a symbol \hat{k}) corresponding to the largest amplitude:

$$\hat{k} = arg {max}_{k ∈ [ 0 , N - 1 ]} {\vert Γ ( k ) \vert}^{2} \qquad ( 3 )$$

Next, the CFO calculating circuit 160 divides the frequency index \hat{k} by the value N, and multiplies the quotient by a sampling frequency fₛ applied to the received signal r at the receiving end to obtain an estimated CFO ξ.

An issue of the CFO estimating apparatus in FIG. 1(A) is that, due to the limitation of the calculation performed by the coherent correlator 110, the property that “a greater square |R(n)|² of the absolute value |R(n)| indicates a higher resemblance of a data segment to the binary sequence c, where the data segment has length L ending at the time point n in the received signal r” is satisfied only when the CFO is in a small value. For a larger CFO, the peak value identified by the time-domain peak searching circuit 120 may not correspond to the real binary sequence c, such that the CFO calculating circuit 160 is caused to yield an incorrect estimated CFO ξ.

To solve the above issue, a differential correlator is proposed to replace the coherent correlator. Referring to FIG. 1(B), in this CFO estimating apparatus, the coherent correlator in FIG. 1(A) is replaced by four differential correlators 171 to 174 and one summing circuit 175. The first-order differential correlator 171 performs the first-order differential calculation of equation (4):

R⁽¹⁾=Σᵢ₌₀^{L-2}r(n−L+i+2)r*(n−L+i+1)c*(i+1)c(i) (4)

The second-order differential correlator 172 performs the second-order differential calculation of equation (5):

R⁽²⁾=Σᵢ₌₀^{L-3}r(n−L+i+3)r*(n−L+i+1)c*(i+2)c(i) (5)

The third-order differential correlator 173 performs the third-order differential calculation of equation (6):

R⁽³⁾=Σᵢ₌₀^{L-4}r(n−L+i+4)r*(n−L+i+1)c*(i+3)c(i) (6)

The fourth-order differential correlator 174 performs the fourth-order differential calculation of equation (7):

R⁽⁴⁾=Σᵢ₌₀^{L-5}r(n−L+i+5)r*(n−L+i+1)c*(i+4)c(i) (7)

The summing circuit 175 sums the calculation results of the differential correlators 171 to 174, as equation (8):

R(n)=|R⁽¹⁾(n)|+|R⁽²⁾(n)|+|R⁽³⁾(n)|+|R⁽⁴⁾(n)| (8)

Similar to the calculation result R(n) generated by the coherent correlator 110 according to equation (1), a greater calculation result R(n) obtained according to equation (8) also means that a higher resemblance of a data segment to the binary sequence c, where the data segment has length L ending at the time point n in the received signal. Similarly, the time-domain peak searching circuit 120 collects multiple calculation results R(n), and identifies therefrom one calculation result R(n) having a largest amplitude, and the data capturing circuit 130 captures the corresponding target data segment y from the received signal r, wherein the target data segment y later serves as the basis for a subsequent circuit to generate the estimated CFO ξ.

In an actual communication environment, the received signal r may be a multipath signal. In a multipath situation, a one-order differential correlation result may simultaneously include peak values having similar amplitudes, with however only one of these peak values corresponding to the real transmission path. Further, in calculation results of different orders, peak values corresponding to the actual transmission path appear at the same time point. Thus, it is necessary that the summing circuit 175 sums the multiple-order differential correlation results to figure out the actual transmission path.

It is known from the above description that, to ensure that the data capturing circuit 130 is able to determine the correct target data segment y, taking into account calculation results of multiple differential correlators is necessary. However, with respect to a larger CFO, although the CFO estimating apparatus in FIG. 1(B) is capable of identifying the correct estimated CFO ξ, the calculation processes of the differential correlators 171 to 174 are extremely complex and consume large amounts of computation resources and time.

### SUMMARY OF THE INVENTION

To solve the above issues, the present invention provides an apparatus and a method for estimating a carrier frequency offset (CFO).

According to an embodiment of the present invention, an apparatus for estimating a CFO includes a differential correlator, a time-domain peak searching circuit, a data capturing circuit, a fast Fourier transform (FFT) circuit, a frequency-domain peak searching circuit, a selecting circuit, and a CFO calculating circuit. The differential correlator performs a differential correlation calculation on a received signal and a section of reference data to generate a plurality of differential correlation results corresponding to a plurality of time points. The time-domain peak searching circuit identifies M number of peak values having largest amplitudes from the plurality of differential correlation results, and outputs each time one of the M number of peak values as a candidate peak value, where M is a positive integer greater than 1. The data capturing circuit captures from the received signal a data segment corresponding to the candidate peak value, wherein the data segment is used as a candidate data segment. The FFT circuit performs FFT on a product of the candidate data segment and a conjugate signal of the section of reference data to obtain a candidate transform result. The frequency-domain peak searching circuit identifies a largest amplitude in the candidate transform result. The selecting circuit determines, according to the largest amplitude in the candidate transform result, whether to select the candidate transform result as a target transform result. The CFO calculating circuit determines an estimated CFO according to a frequency corresponding to the largest amplitude in the target transform result.

According to another embodiment of the present invention, a method for estimating a CFO includes: performing a differential correlation calculation on a received signal and a section of reference data to generate a plurality of differential correlation results corresponding to a plurality of time points; identifying M number of peak values having largest amplitudes from the plurality of differential correlation results, and selecting each time one of the M number of peak values as a candidate peak value, where M is a positive integer greater than 1; after having selected the candidate peak value, capturing from the received signal a data segment corresponding to the candidate peak value as a candidate data segment; performing FFT on a product of the candidate data segment and a conjugate signal of the section of reference data to obtain a candidate transform result; identifying a largest amplitude in the candidate transform result; determining, according to the largest amplitude in the candidate transform result, whether to select the candidate transform result as a target transform result; and after having selected the target transform result, determining an estimated CFO according to a frequency corresponding to the largest amplitude in the target transform result.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) (prior art) is a function block diagram of a current carrier frequency offset (CFO) estimating apparatus using a coherent correlator;

FIG. 1(B) (prior art) is a function block diagram of a current CFO estimating apparatus using a differential correlator;

FIG. 2 is a function block diagram of a CFO estimating apparatus according to an embodiment of the present invention;

FIG. 3 is a detailed example of a selecting circuit according to an embodiment of the present invention;

FIG. 4 is a function block diagram of a CFO estimating apparatus according to another embodiment of the present invention;

FIG. 5 is a function block diagram of a CFO estimating apparatus according to another embodiment of the present invention; and

FIG. 6 is a flowchart of a CFO estimating method according to an embodiment of the present invention.

It should be noted that, the drawings of the present invention include functional block diagrams of multiple functional modules related to one another.

These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

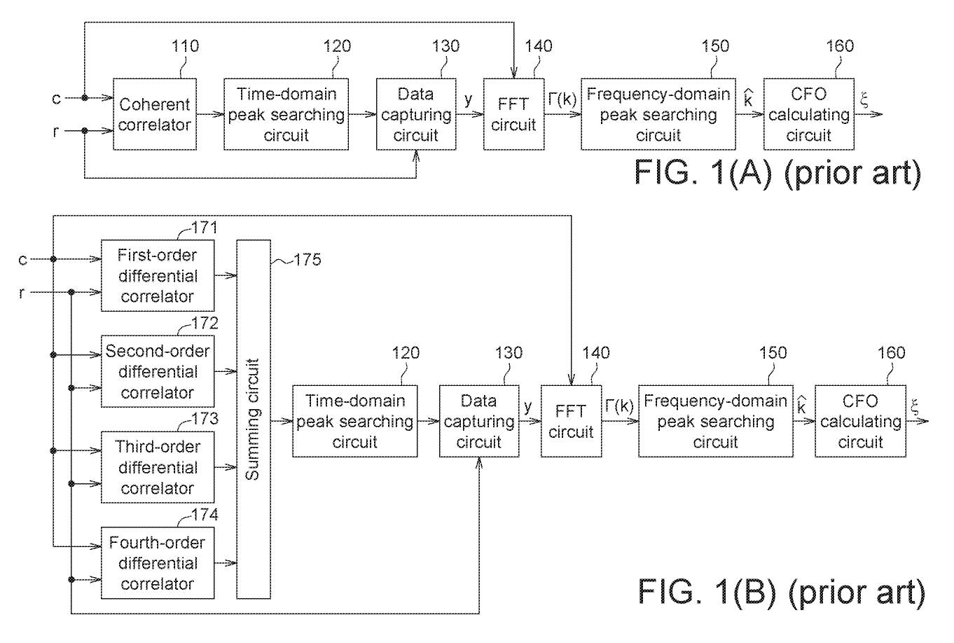

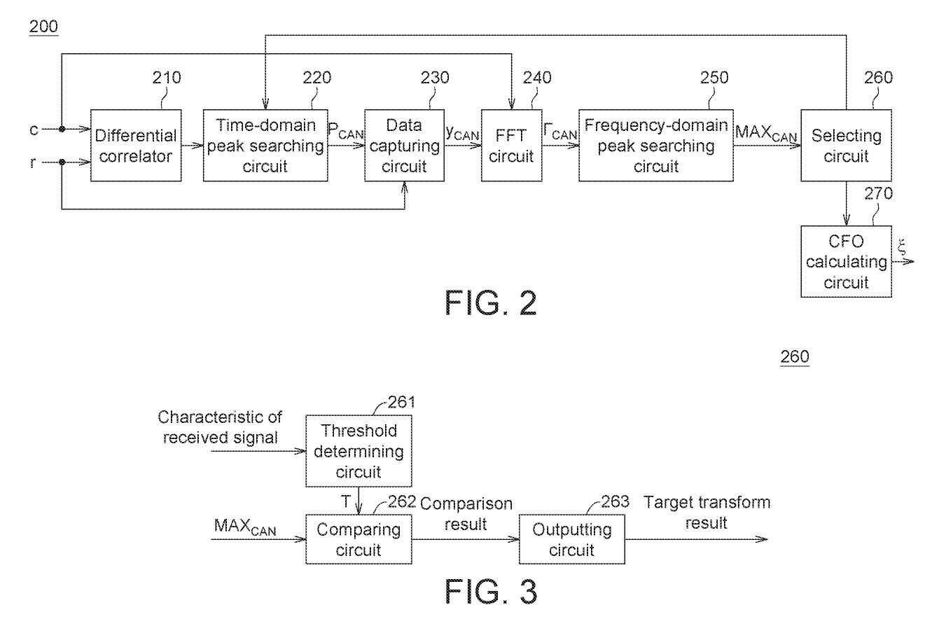

FIG. 1 shows a function block diagram of a carrier frequency offset (CFO) estimating apparatus according to an embodiment of the present invention. In practice, the CFO estimating apparatus may be integrated in various communication systems, for example but not limited to, a Digital Terrestrial Multimedia Broadcast (DTMB) receiver, needing to perform CFO estimation on a section of reference data in a received signal. As shown in FIG. 2, the CFO estimating apparatus 200 includes a differential correlator 210, a time-domain peak searching circuit 220, a data capturing circuit 230, a fast Fourier transform (FFT) circuit 240, a frequency-domain peak searching circuit 250, a selecting circuit and a CFO calculating circuit 270.

An input signal of the CFO estimating apparatus 200 includes a received signal r and a section of reference data c. Theoretically, the received signal r includes the reference data c, and the content, format and length L of the reference data c are defined in the specification of communication protocol and are known data. It should be noted that, the reference data c may be, for example but not limited to, a binary sequence, or an octal or decimal sequence. In brief, the differential correlator 210, the time-domain peak searching circuit 220 and the data capturing circuit 230 identify, from the received signal r, multiple segments that are potentially the reference data c as candidate data segments. The FFT circuit 240, the frequency-domain peak searching circuit 250 and the selecting circuit 260 determine, from these candidate data segments, one data segment most likely corresponding to a real CFO as the basis for the CFO calculating circuit 270 to generate an estimated CFO. Operation details of these circuits are given below.

The differential correlator 210 performs a differential correlation calculation on the received signal r according to the length L and the reference data c to generate a plurality of differential correlation results corresponding to a plurality of time points. For example, assume that the length of one complete frame header and frame body corresponds to 5000 sample results in the received signal r, because the length of a multipath is not more than the above length of the 5000 sample results, the differential correlator 210 is configured to generate differential correlation results corresponding to 5000 consecutive time points. In one embodiment, the differential correlator 210 is designed to perform a first-order differential correlation calculation of equation (9):

R⁽¹⁾(n)=Σᵢ₌₀^{L-2}r(n−L+i+2)r*(n−L+i+1)c*(i+1)c(i) (9)

In equation (9), the symbol n represents a time index, which is a quantity of 5000 in this example, the symbol r(n) represents data content of the received signal r at the time point n, the symbol i is an integral index, the symbol c(i) represents the i^{th} set of data in the reference data c, the symbol c*(i+1) is a conjugate signal of data c(i+1), and the symbol R⁽¹⁾(n) represents a calculation result of the differential correlator 210 corresponding to the time point n. It should be noted that, the scope of the present invention does not limit the calculation performed by the differential correlation 210 to be a first-order differential correlation calculation. For example, the differential correlator 210 may also be designed to calculate a differential correlation result through a second-order differential correlation calculation. The differential correlator 210 is not required to perform differential correlation calculations in multiple different orders as the prior art in FIG. 1(B), nor is the CFO estimating apparatus 200 required to include the summing circuit 175 in FIG. 1(B). Associated details are given below.

The time-domain peak searching circuit 220 identifies M number of peak values having largest amplitudes (i.e., the square |R⁽¹⁾(n)|² of the absolute value |R⁽¹⁾(n)|) from the plurality (e.g., the above 5000) of differential correlation results. Time points of these M number of peak values are most likely an ending position (where the frame header is located) of the reference data c. One of the M number of peak values is outputted each time as a candidate peak value P_{CAN}, where M is a positive integer greater than 1. In practice, the value M may be determined by a circuit designer based on the rule of thumb. For example, if it is known from past experience that, the differential correlation result corresponding to the actual CFO necessarily appears in the first 64 peak values of peak values having the largest amplitudes, the value M may be set to 64.

The data capturing circuit 230 captures, from the received signal r, the data segment corresponding to the candidate peak value P_{CAN} as a candidate data segment y_{CAN}. As previously state, a segment in the section of the reference data c in the received signal r is likely regarded as a candidate data segment. More specifically, the position of the candidate peak value P_{CAN} on the time axis corresponds to a time point (denoted by n_{CAN}). As the length of the reference data c is L, the data capturing circuit 230 captures, from the received signal r, consecutive L sets of data {r(n_{CAN}−L+1), r(n_{CAN}−L+2), . . . , r(n_{CAN})} with the time point n_{CAN} as the ending point, and provides the same as the candidate data segment y_{CAN}={y(0), y(1), . . . , y(L−1)} to the FFT circuit 240.

The FFT circuit 240 calculates a product of the candidate data segment y_{CAN} and a conjugate signal c* of the reference data c, and performs FFT on the product to obtain a candidate transform result Γ_{CAN}, as equation (10):

Γ_{CAN}=Σₙ₌₀^{L-1}y_{CAN}(n)c*(n)e^{-j2πnk/}^{₁} (10)

In equation (10), the symbol N₁ represents the resolution of the FFT (i.e., the number of sampling frequencies), and the symbol k represents an integral index (to be referred to as a frequency index k) ranging between 0 and (N₁−1). In other words, the FFT circuit 240 in total generates N₁ number of transform results Γ(k) (k=0−(N₁−1) corresponding to N₁ frequencies. In the frequency domain, these transform results represent the correlation between the candidate data segment and the reference data c.

Next, to determine, from the N₁ number of transform results, the transform result with highest correlation with respect to the reference data c, the frequency-domain peak searching circuit 250 determines the frequency index k (k=0˜(N₁−1)) corresponding to the largest square |Γ_{CAN}(k)|² of the absolute value |Γ_{CAN}(k)|, wherein the determined frequency index k is used as the largest amplitude MAX_{CAN} in the candidate transform results Γ_{CAN}, wherein MAX_{CAN} is as represented by equation (11) below:

$${MAX}_{CAN} = arg {max}_{k ∈ [ 0 , N - 1 ]} {\vert {Γ}_{CAN} ( k ) \vert}^{2} \qquad ( 11 )$$

The selecting circuit 260 determines, according to the largest amplitude MAX_{CAN} of the candidate transform result, whether to select the candidate transform result as a target transform result Γ_{TAR}, FIG. 3 shows a detailed example of the selecting circuit 260. The selecting circuit 260 includes a threshold providing circuit 261, a comparing circuit 262 and an outputting circuit 263. The threshold providing circuit 261 provides an amplitude threshold T. The comparing circuit 262 compares the amplitude threshold T with the largest amplitude MAX_{CAN} of the candidate transform result to generate a comparison result. If the comparison result indicates that the largest amplitude MAX_{CAN} is higher than amplitude threshold T, the outputting circuit 263 selects the candidate transform result Γ_{CAN} as the target transform result Γ_{TAR}. In contrast, if the largest amplitude MAX_{CAN} is lower than amplitude threshold T, the outputting circuit 263 requests the time-domain peak searching circuit 220 to provide another peak value not yet having been selected as a candidate peak value as a new candidate peak value P_{CAN}, which is then forward to the data capturing circuit 230 and the subsequent circuits to repeated the above inspection process.

In one embodiment, the threshold providing circuit 261 determines the amplitude threshold T according to the number of transmission paths of the received signal r or the length L of the reference data e. More specifically, if the received signal c arrives at a receiving end where the CFO estimating apparatus 200 is located through multiple transmission paths, the signal energy distributed to the various paths is usually lower as the number of transmission paths increases, and so a lower amplitude threshold T should be used. Further, theoretically speaking, the largest amplitude MAX_{TAR} of the target transform result T_{TAR} increases for a longer length L of the reference data c, and so a higher amplitude threshold T should be used.

In the CFO estimating apparatus 200, once one target transform result T_{TAR} has been identified, the selecting circuit 260 no longer requests the time-domain peak searching circuit 220 to provide a new candidate peak value P_{CAN} to the data capturing circuit 230. In another embodiment, the selecting circuit 260 may configure the M number of peak values, identified by the time-domain peak searching circuit 220, to be set one after another as the candidate peak value P_{CAN} to sequentially identify the candidate transform result Γ_{CAN}, and select therefrom one candidate transform result Γ_{CAN} having the largest amplitude MAX_{CAN} as the target transform result Γ_{TAR}.

In practice, the selecting circuit 260 may be implemented by various control and processing platforms, including fixed and programmable logic circuits, e.g., programmable logic gate arrays, application-specific integrated circuits (ASICs), microcontrollers, microprocessors, and digital signal processors (DSPs). Further, the selecting circuit 260 may also be designed to execute a processor command stored in a memory (not shown) to complete associated tasks.

After the target transform result Γ_{TAR} has been determined, the selecting circuit 260 obtains the frequency index k (to be denoted as \hat{k} below) corresponding the largest amplitude MAX_{CAN}, as equation (12):

\hat{k}=arg MAX_{TAR} (12)

The CFO calculating circuit 270 determines an estimated CFO ξ according to the frequency index \hat{k}. In one embodiment, the CFO calculating circuit 270 calculates the estimated CFO according to the frequency index \hat{k}, the value N₁ (i.e., the resolution of FFT performed by the FFT circuit 240), and the sampling frequency fₛ that the receiving end applies on the received signal r, as equation (13):

$$\tilde{ξ} = \{ \begin{matrix}\frac{\hat{k}}{{N}_{1}} \times {f}_{s} & when \hat{k} \leq \frac{{N}_{1}}{2} \\ \frac{( \hat{k} - {N}_{1} )}{{N}_{1}} \times {f}_{s} & when \hat{k} > \frac{{N}_{1}}{2}\end{matrix} \qquad ( 13 )$$

It is seen from the above description that, the CFO estimating apparatus 200 determines the realness (whether or not corresponding to the real reference data c) of a peak value by inspecting the value of the largest amplitude MAX_{CAN} of the candidate transform result Γ_{CAN}. Since the realness of the peak value is not determined based on a summation value of multiple-order differential correlation results, the differential correlator 210 is not required to perform multiple-order differential correlation calculations as the prior art in FIG. 1(B), nor is the CFO estimating apparatus 200 required to include the summing circuit 175 in FIG. 1(B). Further, different from the prior art adopting a coherent correlator in FIG. 1(A), the CFO estimating apparatus 200 of the present invention is still capable of identifying the correct estimated CFO ξ even in a situation of a larger CFO.

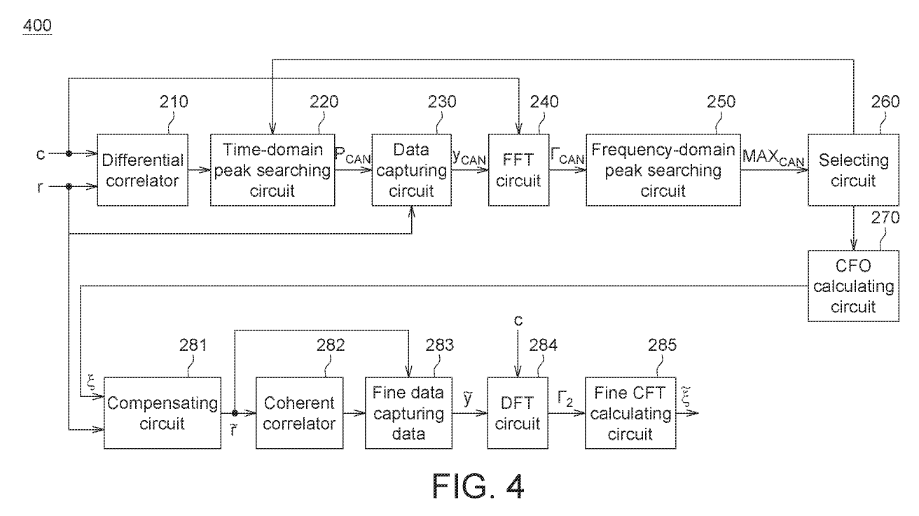

FIG. 4 shows a function block diagram of a CFO estimating apparatus according to another embodiment of the present invention. In addition to the circuits in FIG. 2, the CFO estimating apparatus 400 in FIG. 4 further includes a compensating circuit 281, a coherent correlator 282, a fine data capturing circuit 283, a discrete Fourier transform (DFT) circuit 284, and a fine CFO estimating circuit 285. Operation details of the above additional circuits are given below.

The compensating circuit 281 performs CFO compensation on the received signal r according to the estimated CFO ξ generated by the CFO calculating circuit 270 to generate a compensated received signal \tilde{r}. In practice, the compensating circuit 281 may be implemented by a mixer. It should be noted that, after the received signal r is processed by the compensating circuit 281, it is likely that only a small amount of CFO remains in the compensated signal \tilde{r}.

To further identify the remaining small amount of CFO, the coherent correlator 282 and the fine data capturing circuit 283 are used to more accurately locate the position of the reference data c in the compensated signal \tilde{r}. More specifically, the coherent correlator 282 performs a coherent correlation calculation on the compensated signal \tilde{r} according to the length L and the reference data c to generate a plurality of coherent correlation results \tilde{R}(n) corresponding to a plurality of time points, as equation (14):

\tilde{R}(n)=Σᵢ₌₀^{L-1}\tilde{r}(n−L+i+1)c*(i) (14)

For example, assume that the length of one complete frame header and frame body corresponds to 5000 sample results in the compensated signal \tilde{r}, the coherent correlator 282 may be configured to generate coherent correlation results \tilde{R}(n) corresponding to 5000 consecutive time points n.

Next, the fine data capturing circuit 283 identifies one coherent correlation result having the largest amplitude from the plurality of coherent correlation results \tilde{R}(n), and captures a corresponding fine target data segment \tilde{y} having the length L from the compensated signal \tilde{r}.

The DFT circuit 284 calculates a product of the fine target data segment \tilde{y} and a conjugate signal c* of the reference data c, and performs DFT on the product to generate a transform result Γ₂, as equation (15):

Γ₂(k)=Σₙ₌₀^{L-1}\tilde{γ}(n)c*(n)e^{-j2πnk/N}^{₂} (15)

In equation (15), the symbol N₂ represents the resolution of the DFT, and the symbol k represents an integral index ranging between 0 and (N₂−1).

Next, the fine CFO calculating circuit 285 selects a largest amplitude from the transform result Γ₂, and generates a fine estimated CFO \tilde{ξ} according to the frequency index k (to be denoted by \check{k}) corresponding to the largest amplitude, as equation (16):

$$\tilde{ξ} = \{ \begin{matrix}\frac{\breve{k}}{{N}_{2}} \times {f}_{s} & when \breve{k} \leq \frac{{N}_{2}}{2} \\ \frac{( \breve{k} - {N}_{2} )}{{N}_{2}} \times {f}_{s} & when \breve{k} > \frac{{N}_{2}}{2}\end{matrix} \qquad ( 16 )$$

As previously stated, only a small amount of CFO is likely to remain in the compensated signal \tilde{r}. That is to say, among the transform result Γ₂, the transform result having the largest amplitude would theoretically appear near zero frequency. Therefore, in one embodiment, the DFT circuit 284 is configured to perform the DFT only on a plurality of frequencies near zero frequency, achieving a benefit of reducing computation. For example, if the resolution N₂ of the DFT is 8192, instead of performing the DFT on all of the 8192 frequency indices k, the DFT circuit 284 performs the DFT only on 11 frequency indices k ranging between −5 and 5. In the above situation, the fine estimated CFO \tilde{ξ} is:

$$\tilde{ξ} = \frac{arg {max}_{k ∈ [ - S , S ]} {\vert {Γ}_{2} ( k ) \vert}^{2}}{{N}_{2}} \times {f}_{s} \qquad ( 17 )$$

In one embodiment, the resolution N₂ is set to be higher than the resolution N₁ of the FFT performed by the FFT circuit 230; that is, a higher resolution is used to determine the fine estimated CFO \tilde{ξ}. Further, the resolution N₂ may be set according to a CFO tolerance of a subsequent circuit. For example, assuming the CFO tolerance of a subsequent circuit is 2 KHz, i.e., an error caused by CFO below 2 KHz is tolerable, the resolution N₂ may be set such that the frequency interval fₛ/N₂ is lower than 2 KHz.

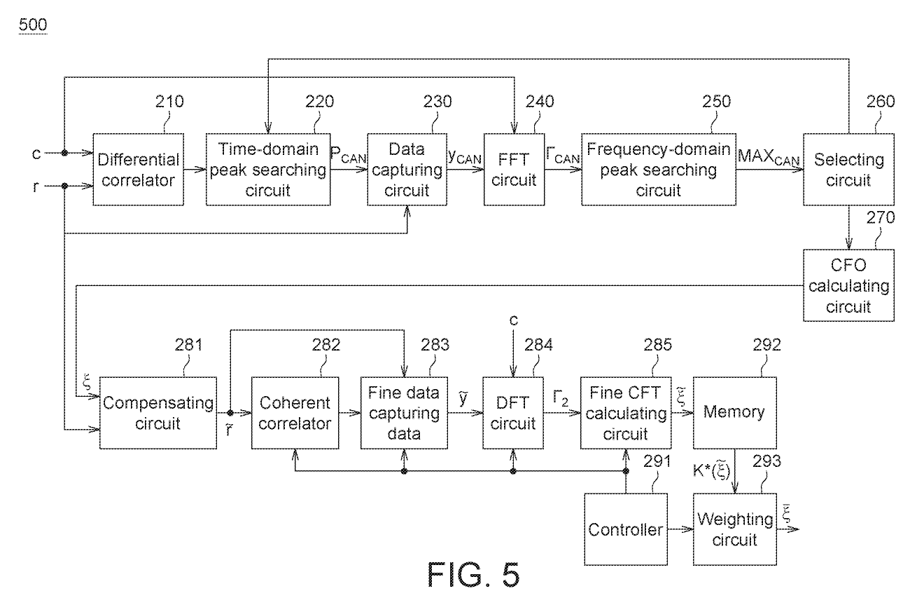

FIG. 5 shows a function block diagram of a CFO estimating apparatus according to another embodiment of the present invention. In addition to the circuits in FIG. 4, the CFO estimating apparatus 500 further includes a controller 291, a memory 292 and a weighting circuit 293. Operation details of these additional circuits are given below.

The controller 291 controls the coherent correlator 282, the fine data capturing circuit 283, the DFT circuit 284 and the fine CFO estimating circuit 285, and generates a fine estimated CFO \tilde{ξ} for each of K sets of signal contents of the compensated signal \tilde{r}, where K is a positive integer greater than one. For example, the K sets of signal contents may be, in the K respective data frames data segments, most likely to be the reference data c.

The memory 292 temporarily stores the fine estimated CFO \tilde{ξ} calculated each time by the fine CFO estimating circuit 285. When all of the K fine estimated CFO \tilde{ξ} have been generated, the controller 291 controls the weighting circuit 293 to fetch the K fine estimated CFO \tilde{ξ} from the memory 292, and performs a weighted summation on the K fine estimated CFO \tilde{ξ} to generate a weighted estimated CFO \tilde{ξ}. Taking the value K set as 5 for instance, the weighting circuit 293 may set all weightings to 0.2, i.e., calculating an average value of five fine estimated CFO \tilde{ξ}. By increasing the number of reference data, the weighted estimated CFO \tilde{ξ} may have a higher reliability.

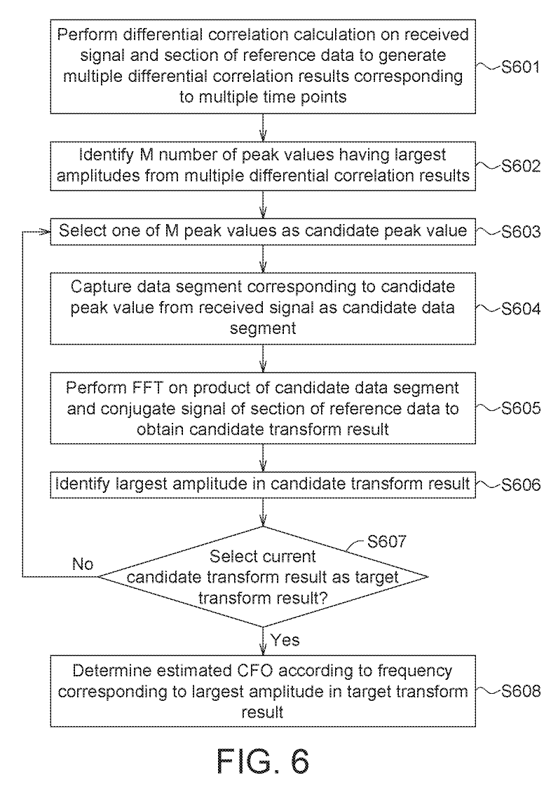

FIG. 6 shows a flowchart of a CFO estimating method according to another embodiment of the present invention. In step S601, a differential correlation calculation is performed on a received signal to generate a plurality of differential correlation results corresponding to a plurality of time points. In step S602, M number of peak values having largest amplitudes are identified from the plurality of differential correlation results, where M is a positive integer greater than M. In step S603, a peak value that has not yet been selected as a candidate peak value is selected as a candidate peak value from the M number of peak values. In step S604, a data segment corresponding to the selected peak value is captured from the received signal, wherein the data segment is used as a candidate data segment. In step S605, FFT is performed on a product of the candidate data segment and a section of reference data to obtain a candidate transform result. In step S606, a largest amplitude in the candidate transform result is identified. In step S607, it is determined, according to the largest amplitude in the candidate transform result, whether to select the candidate transform result as a target transform result. If the determination result of step S607 is affirmative, step S608 is performed to determine an estimated CFO according to a frequency corresponding to the largest amplitude in the target transform result. If the determination result of step S607 is negative, steps S603 to S607 are repeated.

One person skilled in the art can appreciate that, operation variations in the description associated with the CFO estimating apparatuses 200, 400 and 500 are applicable to the CFT estimating method in FIG. 6, and such repeated details shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. Further, the mathematical expressions in the disclosure are for illustrating principles and logics associated with the embodiments of the present invention. Unless otherwise specified, these mathematical expressions do not levy limitations to the present invention. One person skilled in the art can understand that, there are various other technologies capable of realizing the physical forms corresponding to these mathematical expressions.

What is claimed is:

1. An apparatus for estimating a carrier frequency offset (CFO), comprising:
a differential correlator, performing a differential correlation calculation on a received signal and a section of reference data to generate a plurality of differential correlation results corresponding to a plurality of time points;
a time-domain peak searching circuit, identifying M number of peak values having largest amplitudes from the plurality of differential correlation results, and outputting each time one of the M number of peak values as a candidate peak value, where M is a positive integer greater than one;
a data capturing circuit, capturing from the received signal a data segment corresponding to the candidate peak value, wherein the data segment is used as a candidate data segment;
a fast Fourier transform (FFT) circuit, performing FFT on a product of the candidate data segment and a conjugate signal of the section of reference data to obtain a candidate transform result;
a frequency-domain peak searching circuit, identifying a largest amplitude in the candidate transform result;
a selecting circuit, determining, according to the largest amplitude in the candidate transform result, whether to select the candidate transform result as a target transform result; and
a CFO calculating circuit, determining an estimated CFO according to a frequency corresponding to the largest amplitude in the target transform result.

2. The apparatus according to claim 1, wherein the differential correlator performs a first-order differential correlation calculation on the received signal to generate the plurality of differential correlation results.

3. The apparatus according to claim 1, wherein the selecting circuit comprises:
a threshold providing circuit, providing an amplitude threshold;
a comparing circuit, comparing the amplitude threshold with the largest amplitude in the candidate transform result to generate a comparison result; and
an outputting circuit, if the comparison result indicates that the largest amplitude is higher than the amplitude threshold, the outputting circuit selecting the candidate transform result as the target transform result outputted to the CFO calculating circuit; if the comparison result indicates that the largest amplitude is lower than the amplitude threshold, the outputting circuit requesting the time-domain peak searching circuit to provide a new candidate peak value to the data capturing circuit.

4. The apparatus according to claim 3, wherein the threshold providing circuit determines the threshold used by the comparing circuit according to a quantity of transmission paths of the received signal or a known data length in the received signal.

5. The apparatus according to claim 1, further comprising:
a compensating circuit, performing CFO compensation on the received signal according to the estimated CFO to generate a compensated signal;
a coherent correlator, performing a coherent correlation calculation on the compensated signal to generate a plurality of coherent correlation results corresponding to a plurality of time points;
a fine data capturing circuit, identifying a largest coherent correlation result having a largest amplitude from the plurality of coherent correlation results, and capturing a corresponding fine target data segment from the compensated signal;
a discrete Fourier transform (DFT) circuit, calculating a product of the fine target data segment and a conjugate signal of the section of reference data, and performing DFT on the product to generate a transform result;
a fine CFO calculating circuit, selecting a largest amplitude in the transform result, and generating a fine estimated CFO according to a frequency corresponding to the largest amplitude.

6. The apparatus according to claim 5, wherein the DFT circuit performs the DFT on only a plurality of frequencies near zero frequency.

7. The apparatus according to claim 5, wherein a resolution of the DFT circuit is determined according to a CFO tolerance of a subsequent circuit.

8. The apparatus according to claim 5, wherein a resolution of the DFT circuit is set to be higher than a resolution of the FFT performed by the FFT circuit.

9. The apparatus according to claim 5, further comprising:
a controller, controlling the coherent correlator, the fine data capturing circuit, the DFT circuit and the fine CFO calculating circuit, and generating a fine estimated CFO for each of K sets of data contents in the compensated signal to generate K number of fine estimated CFOs, where K is a positive integer greater than one;
a memory, temporarily storing the K number of fine estimated CFOs; and
a weighting circuit, performing a weighted summation on the K number of fine estimated CFOs to generate a weighted estimated CFO.

10. A method for estimating a carrier frequency offset (CFO), comprising:
a) performing a differential correlation calculation on a received signal and a section of reference data to generate a plurality of differential correlation results corresponding to a plurality of time points;
b) identifying M number of peak values having largest amplitudes from the plurality of differential correlation results, where M is a positive integer greater than one;
c) outputting each time one of the M number of peak values as a candidate peak value, and performing:
c1) capturing from the received signal a data segment corresponding to the candidate peak value, and using the data segment as a candidate data segment;
c2) performing fast Fourier transform (FFT) on a product of the candidate data segment and a conjugate signal of the section of reference data to obtain a candidate transform result;
c3) identifying a largest amplitude in the candidate transform result; and
c4) determining, according to the largest amplitude of the candidate transform result, whether to select the candidate transform result as a target transform result; and
d) determining an estimated CFO according to a frequency corresponding to the largest amplitude in the target transform result.

11. The method according to claim 10, wherein step (a) performs a first-order differential correlation calculation on the received signal to generate the plurality of differential correlation results.

12. The method according to claim 10, wherein step (c4) comprises:
comparing an amplitude threshold with the largest amplitude in the candidate transform result to generate a comparison result;
if the comparison result indicates that the largest amplitude is higher than the amplitude threshold, selecting the candidate transform result as the target transform result; and
if the comparison result indicates that the largest amplitude is lower than the amplitude threshold, repeating step (c) for a new candidate peak value.

13. The method according to claim 12, wherein the threshold providing circuit determines the threshold used by the comparing circuit according to a quantity of transmission paths of the received signal or a known data length in the received signal.

14. The method according to claim 10, further comprising:
e) performing CFO compensation on the received signal according to the estimated CFO to generate a compensated signal;
f) performing a coherent correlation calculation on the compensated signal to generate a plurality of coherent correlation results corresponding to a plurality of time points;
g) identifying a largest coherent correlation result having a largest amplitude from the plurality of coherent correlation results, and capturing a corresponding fine target data segment from the compensated signal;
h) calculating a product of the fine target data segment and a conjugate signal of the section of reference data, and performing discrete Fourier transform (DFT) on the product to generate a transform result; and
i) selecting a largest amplitude in the transform result, and generating a fine estimated CFO according to a frequency corresponding to the largest amplitude.

15. The method according to claim 14, wherein step (h) performs the DFT on only a plurality of frequencies near zero frequency.

16. The method according to claim 14, wherein a resolution of the DFT in step (h) is determined according to a CFO tolerance of a subsequent circuit.

17. The method according to claim 14, wherein a resolution of the DFT in step (h) is set to be higher than a resolution of the FFT in step (c2).

18. The method according to claim 14, further comprising:
performing steps (f) to (i) on each of K sets of data contents in the compensated signal to generate K number of fine estimated CFOs, where K is a positive integer greater than one; and
performing a weighted summation on the K number of fine estimated CFOs to generate a weighted estimated CFO.
